(19) United States
(12) Patent Application Publication
(10) Pub. No.: US 2025/0159265 A1
(43) Pub. Date: May 15, 2025

(54) Cloud Application Data Streaming Using Drawing Data

(71) Applicant: Google LLC, Mountain View, CA (US)

(72) Inventors: Andreas Huber, Santa Clara, CA (US); Iliyan Malchev, San Francisco, CA (US)

(21) Appl. No.: 18/722,274

(22) PCT Filed: Sep. 22, 2022
(86) PCT No.: PCT/US2022/044362

§ 371 Date: Jun. 20, 2024

Related U.S. Application Data
(60) Provisional application No. 63/291,508, filed on Dec. 20, 2021.

(51) Int. Cl. H04N 21/234; H04N 21/2343; H04N 21/4223

(52) U.S. Cl. CPC H04N 21/23412; H04N 21/234372; H04N 21/4223

(57) ABSTRACT

A cloud-based application streaming system [100] is implemented to stream an application to a client device [116]. The system includes a server [102] running the application on an application instance [104] configured to render video frames and determine drawing data [106] based on the application. The server then encodes the video frames and provides the video frames and drawing data to the client device as an application data stream [114]. In response to receiving the application data stream, the client device is configured to display at least a portion of the application data stream based on the drawing data. Additionally, the client device is configured to receive inputs and provide an input data stream [128] representing these inputs to the server. In response to the input data stream, the server modifies the application based on the input data stream and provides a modified application data stream to the client device.

### BACKGROUND

Cloud-based streaming systems employ cloud-based servers to render and stream audiovisual data of an application to a client device. To facilitate the streaming of the audiovisual data, the cloud-based servers use encoders to first encode the audiovisual data before it is provided as a stream to the client device. However, the resulting streams can require more bandwidth than is available, leading to lost audiovisual data and reduced performance. Additionally, the resolution of the stream is determined by the cloud-based server, leading to greater bandwidth requirements as higher resolutions are demanded by client devices.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a cloud-based application system for streaming one or more applications to one or more client devices using drawing data, in accordance with some embodiments.

FIG. 2 is a block diagram of a computing device configured to stream one or more applications to one or more client devices using drawing data, in accordance with some embodiments.

FIG. 3 is a block diagram of a client device configured to provide inputs for one or more application data streams using drawing data, in accordance with some embodiments.

FIG. 4 is a flow diagram of an example process of streaming an application to a client device using drawing data, in accordance with some embodiments.

FIG. 5 is a flow diagram of an example method for streaming one or more applications to one or more client devices using drawing data, in accordance with some embodiments.

FIG. 6 is a flow diagram of an example method for providing inputs to one or more application data streams, in accordance with some embodiments.

### DETAILED DESCRIPTION

Techniques and systems described herein are directed to a cloud-based application system configured to stream one or more applications to one or more client devices using drawing data. The system includes a cloud-based application server configured to run one or more applications on an application instance that is configured to render audiovisual data based on the application running. In response to the audiovisual data being rendered, the server encodes at least a portion of the audiovisual data, determines drawing data based on the audiovisual data, or both. The drawing data includes data structures (e.g., scene graphs, graphs, data trees), operations, commands, and routines used in the rendering of audiovisual data (e.g., graphical objects, video frames, images, and layers) by the application instance. The server then provides at least a portion of the encoded audiovisual data, the drawings data, or both to a client device as an application data stream. The client device is then configured to display at least a portion of the application data stream based on the drawing data. Providing the drawing data to the client device as part of the application data stream helps reduce the bandwidth needed by the application data stream as the number of video frames or the amount of data in a video frame needed in an application data stream is reduced. Additionally, providing the drawing data to the client device as part of an application data stream allows a client device to render and display portions of the application data stream at different resolutions by using the drawing data, increasing the versatility of the application data stream.

Additionally, while the client device is displaying the application data stream, the client device is configured to receive one or more inputs. In response to receiving an input, the client device is configured to transmit an input data stream to the server that includes data representing one or more inputs received at the client device. In response to the input data stream, the server is configured to modify an application running on an application instance based on the input data stream. The server then provides a modified application data stream to the client device based on the modified application. In this way, input devices included at the client device are used as input devices for the application running on the cloud-based application server.

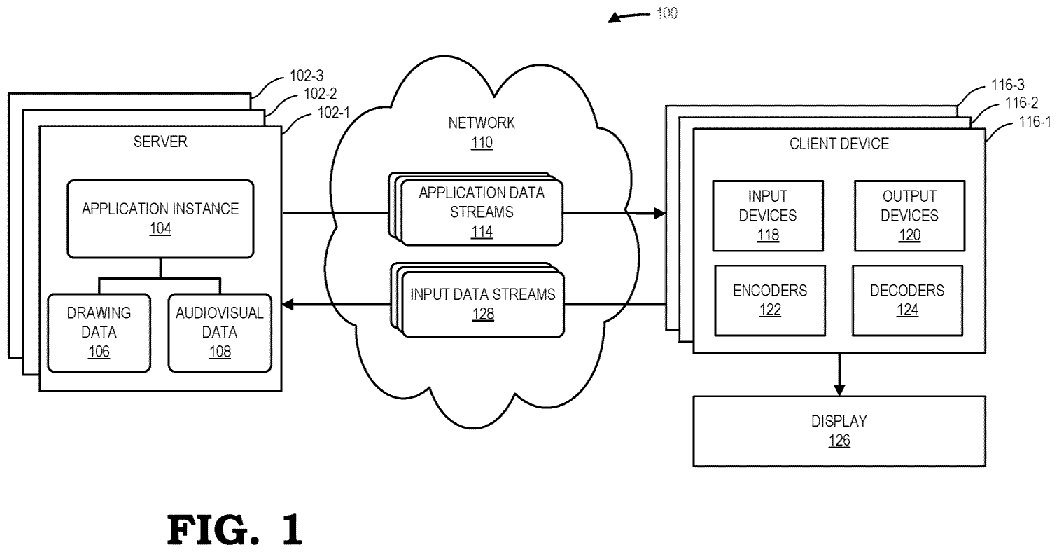

Referring now to FIG. 1, a cloud-based application system 100 for streaming one or more applications to one or more client devices 116 is presented. To stream one or more applications to one or more client devices 116, the cloud-based application system 100 includes one or more cloud-based application servers 102 each communicatively coupled to one or more client devices 116 by at least one network 110. Network 110 is configured to allow for the transmission and reception of data between any of servers 102 and client devices 116 and includes, for example, Ethernet, the Internet, Wi-Fi, or any combination thereof. Though in the illustrated embodiment, three servers 102-1, 102-2, and 102-3 are presented supporting three client devices 116-1, 116-2, and 116-3, in other embodiments, any number of servers 102 may be implemented supporting any number of client devices 116. Each client device 116 includes, for example, a compute-enabled phone (smartphone), notebook computer, desktop computer, tablet computer, virtual assistant device, compute-enabled television (smart TV), a web browser, or any combination thereof, to name a few.

In embodiments, each server 102 includes a computing device, for example, a cloud server, a virtual server, or both configured to support one or more application data streams 114 initiated by one or more client devices 116. Application data streams 114, as used herein, include data necessary for, aiding in, or helpful for an application running on a server 102 to be partially or fully simulated on one or more client devices 116. For example, a client device 116 is configured to render and display at least a portion of an application data stream 114 so that the application running on a server 102 is partially or fully simulated. According to embodiments, one or more application data streams 114 include encoded video, encoded audio, or both necessary for, aiding in, or helpful for partially or fully simulating an application running on a server 102 to be partially or fully simulated on one or more client devices 116. As another example, one or more application data streams 114 include drawing data necessary for, aiding in, or helpful for partially or fully simulating an application running on a server 102 to be partially or fully simulated on one or more client devices 116. To facilitate one or more application data streams 114, each server 102 runs an application instance 104 for each application to be streamed to a client device 116. Each application instance 104 includes hardware and software configured to facilitate the execution of at least a portion of an application. Such facilitation includes performing one or more operations of an application, for example, rendering video frames, rendering audio data, rendering graphics, generating drawing data (e.g., scene graphs), controlling data streams, input data processing, network management, communication management, authentication processes, or any combination thereof, to name a few. According to embodiments, data resulting from the operations performed by an application instance 104 is provided to one or more client devices 116 as part of one or more application data streams 114.

According to embodiments, one or more application instances 104 are configured to generate audiovisual data 108 related to the application running on the application instance 104. Audiovisual data 108 includes, for example, video frames, audio files, graphical objects, or any combination thereof. In response to an application instance 104 generating audiovisual data 108, one or more servers 102 related to the application instance 104 are configured to encode at least a portion of the audiovisual data 108 using one or more video codecs (e.g., H.264, H.265, VP8, VP9, AV1) audio codecs (MPEG-2 Audio Layer 3 (MP3), Free Lossless Audio Codec (FLAC), Advanced Audio Coding (AAC), Waveform Audio File Format (WAV), Audio Interchange File Format (AIFF), Opus), or both. After encoding the audiovisual data 108, a server 102 is configured to provide at least a portion of the encoded audiovisual data to one or more client devices 116 as at least a portion of an application data stream 114 so that the application related to the audiovisual data 108 (e.g., the application running on the application instance 104 when the audiovisual data was generated) can be fully or partially simulated on the client devices 116.

In embodiments, one or more application instances 104 are configured to determine drawing data 106. Drawing data 106 includes one or more data structures (e.g., scene graphs, graphs, data trees), operations, commands, routines, or any combination thereof necessary for, aiding in, or helpful to the rendering of one or more video frames, layers, graphical objects, images, or any combination thereof of audiovisual data 108. That is to say, drawing data 106 includes data structures, operations, commands, routines, or any combination thereof used to render one or more graphical objects, compose one or more layers, generate one or more video frames, generate one or more images, or any combination thereof for the application running on application instance 104. For example, drawing data 106 includes one or more operations, commands, routines, or any combination thereof associated with one or more steps of a graphics pipeline used to render one or more graphical objects. As another example, drawing data 106 includes one or more operations, commands, routines, or any combination thereof used in the generation of primitives, clipping, rasterization, pixel operations, texture mapping, frame buffer operations, tessellation, or any combination thereof used in one or more graphical objects, layers, or both. As yet another example, drawing data 106 includes data structures representing, for example, a structured representation of at least a portion of a video frame, layer, image, or any combination thereof and data representing graphical objects, attributes of graphical objects, and relationships between graphical objects within at least the portion of the video frame, layer, or image. These data structures include, for example, scene graphs (including, for example, shape nodes, property nodes, and group nodes), data trees, graphs, or any combination thereof.

In embodiments, drawing data 106 is provided to a client device 116 as at least a portion of an application data stream 114. Providing the drawing data 106 to the client devices 116 as part of an application data stream 114 helps reduce the bandwidth needed to transmit the application data stream 114 to a client device 116. For example, including drawing data 106 in the application data stream 114 helps reduce the number of video frames or the amount of data in a video frame needed in an application data stream 114. Additionally, providing the drawing data 106 to the client devices 116 as part of an application data stream 114 allows the client devices 116 to render and display portions of the application data stream 114 at different resolutions, increasing the versatility of the application data stream 114.

According to embodiments, one or more graphical objects, layers, video frames or any combination thereof include one or more attributes, for example, color, shape, size, scale factor, position, or any combination thereof. In embodiments, drawing data 106 includes values representing the difference between the attributes of one or more graphical objects, layers, video frames, or any combination and the attributes one or more reference graphical objects, layers, video frames, or any combination thereof. That is to say, the drawing data 106 includes values representing the changes in the attributes of one or more graphical objects, layers, video frames or any combination from a reference graphical objects, layers, video frames, or any combination thereof. The reference graphical objects, layers, video frames, or any combination thereof include, for example, previously rendered graphical objects, layers, video frames, or any combination thereof previously rendered by an application instance 104 running an application. In this way, the changes to attributes are included in an application data stream 114 rather than entire graphical objects, layers, or video frames helping to reduce the bandwidth needed by the application data stream 114.

In response to receiving one or more application data streams 114, a client device 116 is configured to output at least a portion of the received application data stream 114. To output portions of an application data stream 114, a client device 116 includes or is otherwise coupled to one or more output devices 120 that include, for example, speakers, lights, servos, motors, or any combination thereof. For example, output devices 120 include one or more speakers configured to output at least a portion of an application data stream 114 (e.g., an audio file). Further, a client device 116 includes or is otherwise coupled to a display 126 (e.g., liquid crystal displays (LCD), light-emitting diode (LED) displays, organic light-emitting diode (OLED) displays, cathode ray tube (CRT) displays) configured to display at least a portion of an application data stream 114 (e.g., video frames, graphical objects). To facilitate the display of the application data stream 114 on, for example, display 126, client device 116 includes one or more decoders that include hardware and software configured to decode one or more encoded video frames of an application data stream 114 using one or more video codecs (e.g., H.264, H.265, VP8, VP9, AV1), decode one or more encoded audio filed using one or more audio codecs (MP3, Free FLAC, AAC, WAV, AIFF, Opus), or both. Further, to facilitate the display of the application data stream 114 on, for example, display 126, a client device 116 is configured to display a least a portion of the application data stream 114 based on the drawing data 106 of the application data stream 114. For example, a client device 116 is configured to render one or more graphical objects based on the drawing data 106 in an application data stream 114. As another example, a client device 116 is configured to perform the generation of primitives, clipping, rasterization, pixel operations, texture mapping, frame buffer operations, tessellation, or any combination thereof based on the drawing data 106 in an application data stream 114 to render at least a portion of an application data stream 114 on display 126.

In embodiments, a client device 116 includes or is otherwise coupled to one or more input devices 118 configured to receive one or more inputs while an application is being shared with the client device 116 (e.g., while the client device 116 is receiving an application data stream 114). Input devices 118 includes, for example, one or more touchscreens, computer mice, keyboards, microphones, cameras, buttons, accelerometers, or any combination thereof configured to receive or capture, for example, gestures (e.g., swipes, clicks, taps), mouse clicks, keystrokes, button presses, audio, video, pictures, angles, or any combination thereof, to name a few. According to embodiments, in response to receiving one or more inputs at one or more inputs devices 118, the client device is configured to transmit, via network 110, an input data stream 128 to one or more servers 102 (e.g., the server 102 running the application being shared with the client device 116). An input data stream 128 includes data representing one or more inputs received at one or more input devices 118 of a client device 116. According to embodiments, client device 116 includes one or more encoders 122 that include hardware and software configured to encode one or more inputs and provide the encoded input as at least a portion of an input data stream 128 to a server 102. For example, encoders 122 are configured to encode video, pictures, and audio capture by one or more input devices 118 using or more video codecs (e.g., H.264, H.265, VP8, VP9, AV1), audio codecs (MP3, FLAC, AAC, WAV, AIFF, Opus), or both.

In response to receiving an input data stream 128, a server 102 is configured to modify the application running on a respective application instance 104. For example, a server 102 is configured to provide at least a portion of an input data stream 128 as an input to the application running on a respective application instance 104. As another example, a server 102 is configured to determine one or more inputs to provide to the application running on a respective application instance 104 based on the input data stream 128. By modifying the application running on a respective application instance 104 based on the input data stream 128, the input devices 118 of a client device are used as input devices for the application running on the respective application instance 104. As such, the input devices 118 of a client device 116 are used to interact with the application partially or fully simulated on the client device 116.

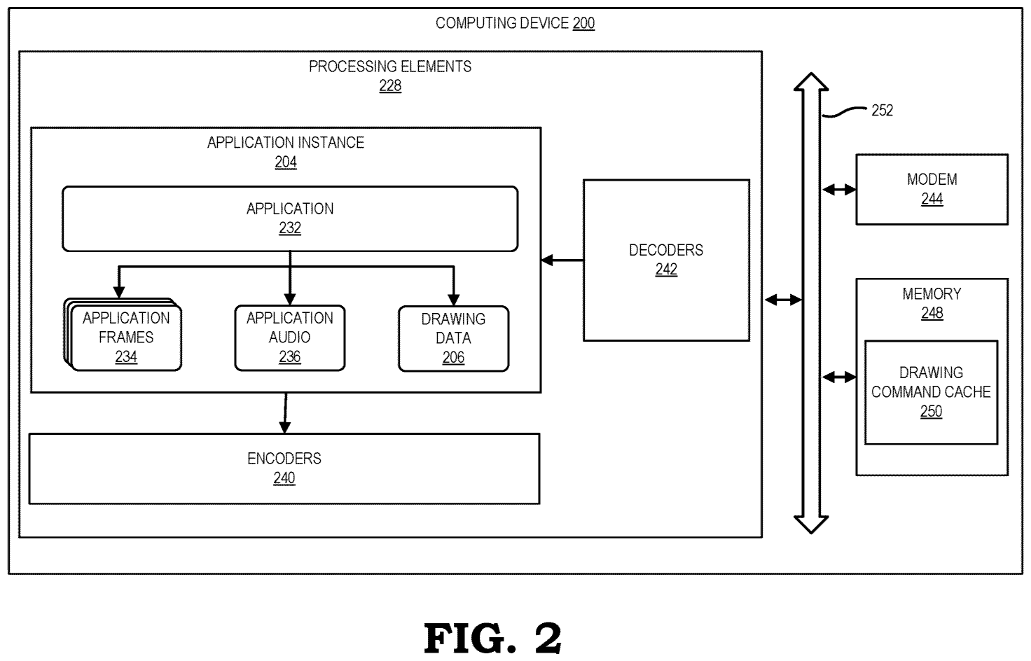

Referring now to FIG. 2, a computing device 200, similar to or the same as server 102, is presented. In embodiments, computing device 200 includes one or more processing elements (e.g., processing cores), modem 244 configured to communicatively couple to one or more networks (e.g., network 110), and memory 248. In embodiments, one or more portions of computing device 200 (e.g., processing elements 228, modem 244, memory 248) are in communication via a bus 252. In embodiments, computing device 200 is configured to run an application 232 using an application instance 204, similar to or the same as application instance 104. Application 232 includes, for example, video calling applications, presentation applications, meeting applications, audio streaming applications, video streaming applications, or any combination thereof. In embodiments, the application instance 204 is configured to generate application frames (e.g., video frames) 234, application audio 236, and drawing data 206, similar to or the same as drawing data 106, according to application 232. For example, the application instance 204 renders one or more application frames 234 according to commands of the application. As another example, the application instance renders application audio (e.g., audio files, sounds) according to the instructions of the application. As yet another example, the application instance 204 generates drawing data 206 configured to render a display environment, picture, image, scene, video frame, or any combination thereof according to the application 232. Processing elements 228 further include one or more encoders 240 including hardware and software configured to encode application frames 234 according to one or more video codecs (e.g., H.264, H.265, VP8, VP9, AV1), encode application audio 236 according to one or more audio codecs (MP3, FLAC, AAC, WAV, AIFF, Opus), or both. In response to application frames 234, application audio 236, or both being encoded, processing elements 228 are configured to provide at least a portion of the encoded application frames and application audio to one or more client devices 116 as an application data stream 114.

According to embodiments, computing device 200 further includes a memory 248 (e.g., solid-state memory, random-access memory (RAM), read-only memory (ROM), programmable read-only memory (PROM), electronically erasable read-only memory (EEPROM), a hard-disk drive (HDD), or any combination thereof) that includes drawing data cache 250. Drawing data cache 250 is configured to store drawing data 206 (e.g., scene graphs) generated by the application instance 204 for rendering one or more graphical objects, layers, images, or video frames according to application 232. In embodiments, drawing data cache 250 is further configured to store one or more changes in attributes to graphical objects, layers, or video frames as compared to a reference graphical object, layer, or video frame. In embodiments, computing device 200 is configured to include drawing data 206 stored in drawing data cache 250 in one or more application data streams 114 provided to one or more client devices 116. For example, computing device 200 is configured to include one or more scene graphs in an application data stream 114.

In embodiments, computing device 200 is configured to receive one or more input data streams 128 from one or more client devices 116 and, in response, modify the application 232 according to the input data streams 128. For example, computing device 200 is configured to provide at least a portion of an input data stream 128 as an input to application 232. As another example, computing device 200 is configured to determine one or more inputs for application 232 based on an input data stream 128. According to embodiments, computing device 200 includes decoders 242 including hardware and software configured to decode at least a portion of an input data stream 128. For example, decoders 242 are configured to decode encoded video from a camera in an input data stream 128 according to one or more video codes (e.g., H.264, H.265, VP8, VP9, AV1). As another example, decoders 242 are configured to decode audio from a microphone in an input data stream 128 according to one or more audio codecs (MP3, FLAC, AAC, WAV, AIFF, Opus).

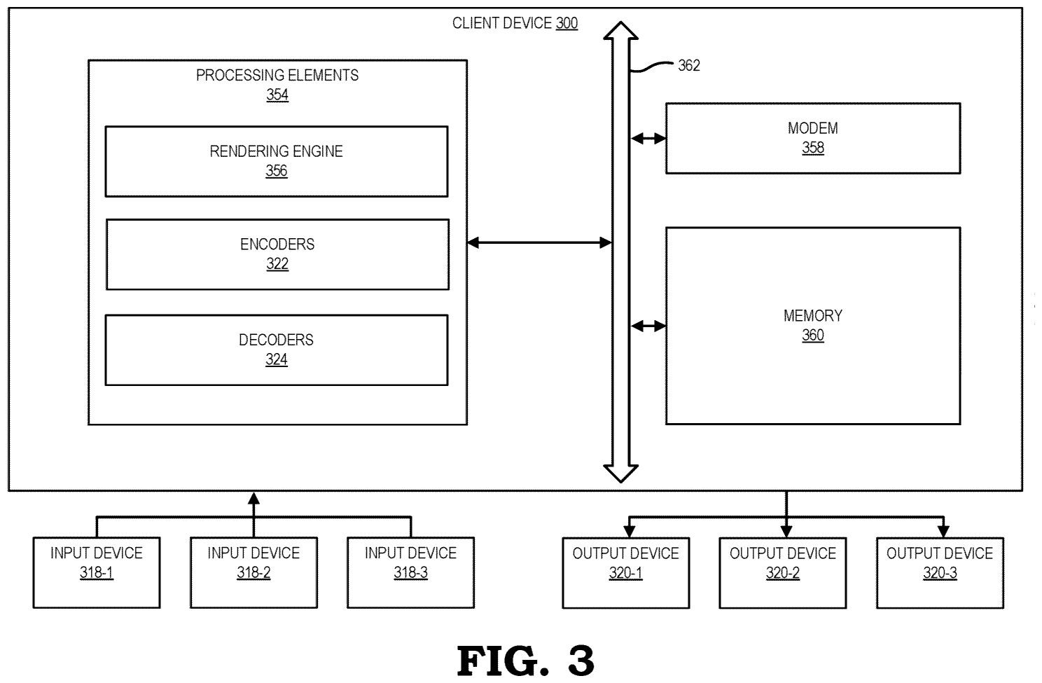

Referring now to FIG. 3, a client device 300, similar to or the same as client device 116, is presented. The client device 300 includes, for example, processing elements (e.g., processing cores) 354, modem 358 configured to communicatively couple to one or more networks (e.g., network 110), and memory 360. According to embodiments, one or more portions of the client device 300 (e.g., processing elements 354, modem 358, and memory 360) are communicatively coupled by a bus 362. In embodiments, client device 300 is configured to receive one or more application data streams 114 and display at least a portion of the received application data streams 114. To this end, client device 300 includes decoders 324 configured to decode encoded application frames and audio in a received application data stream 114. Decoders 324 include hardware and software configured to decode video frames according to one or more video codes (e.g., H.264, H.265, VP8, VP9, AV1) and decode audio according to one or more audio codecs (MP3, FLAC, AAC, WAV, AIFF, Opus). In response to decoding one or more application frames (e.g., video frames), client device 300 is configured to display at least a portion of the decoded application frame on a display similar to or the same as display 126. In response to decoding audio, client device 300 is configured to output the decoded audio using one or more output devices 320, similar to or the same as output devices 120, included in or otherwise coupled to client device 300. Each output device 320 includes, for example, one or more speakers, lights, servos, motors, or any combination thereof, configured to output at least a portion of a received application data stream 114. Though the example embodiment illustrated in FIG. 3 presents three output devices (320-1, 320-2, 320-3) included in or otherwise coupled to client device 300, in other embodiments, any number of output devices 320 may be included in or otherwise coupled to client device 300. According to embodiments, client device 300 further includes rendering engine 356 that includes hardware and software configured to render scenes, images, graphical objects, layers, or any combination thereof, based on drawing data, similar to or the same as drawing data 106, 206, included in an application data stream 114. For example, rendering engine 356 is configured to render one or more graphical objects, layers, video frames, or any combination thereof based on a scene graph. In embodiments, data rendered by rendering engine 356 (e.g., graphical objects, layers, video frames) is displayed concurrently with one or more decoded application frames.

While at least a portion of an application data stream 114 is output by output devices 320, displayed on a display, or both, one or more input devices 318, similar to or the same as input devices 118, included in or otherwise coupled to client device 300, are configured to receive one or more inputs. Input devices 318 include, for example, one or more touchscreens, computer mice, keyboards, microphones, cameras, buttons, accelerometers, or any combination thereof configured to receive or capture, for example, gestures (e.g., swipes, clicks, taps), mouse clicks, keystrokes, button presses, audio, video, pictures, angles, or any combination thereof, to name a few. In embodiments, client device 300 is configured to provide an input data stream 128 representing one or more inputs received at the input devices 318 to one or more servers 102. Though the example embodiment illustrated in FIG. 3 presents three input devices (318-1, 318-2, 318-3) included in or otherwise coupled to client device 300, in other embodiments any number of input devices 318 may be included in or otherwise coupled to client device 300. According to embodiments, client device 300 includes encoders 322, similar to or the same as encoders 122, that include hardware and software configured to encode one or more inputs received by input devices 318. For example, encoders 322 are configured to encode video and pictures captured by a camera according to one or more video codecs (e.g., H.264, H.265, VP8, VP9, AV1). As another example, encoders 322 are configured to encode audio received by a microphone according to one or more audio codecs (MP3, FLAC, AAC, WAV, AIFF, Opus). In response to encoding videos, pictures, audio, or any combination thereof, the client device 300 is configured to provide the encoded videos, pictures, and audio to a server 102 as part of an input data stream 128.

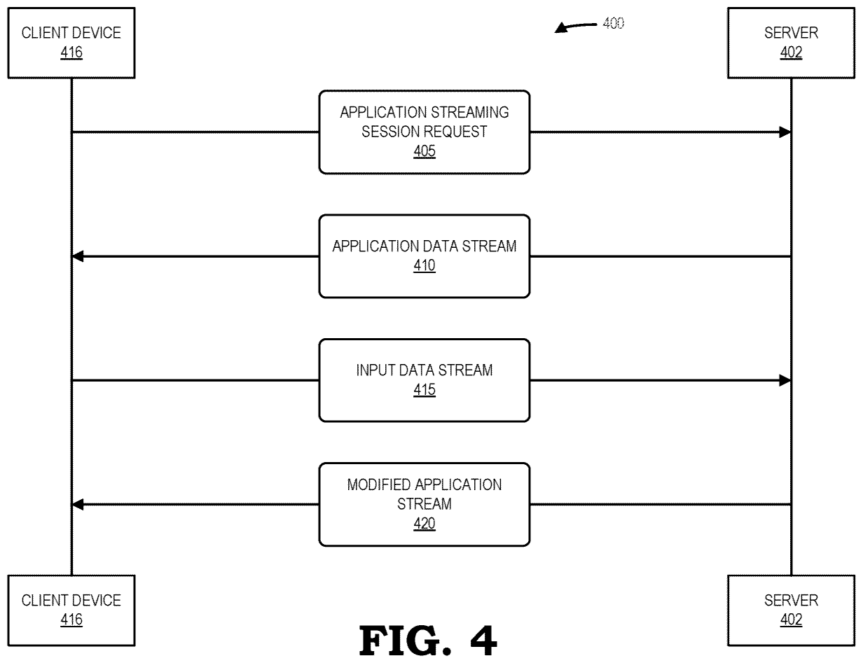

Referring now to FIG. 4, a flow diagram of an example process 400 of streaming an application to a client device is presented. Process 400 includes a client device 416, similar to or the same as client device 116, 300, transmitting an application streaming session request 405 to one or more servers 402, similar to or the same as server 102 or computing device 200. The application streaming session request 405 includes data requesting the initiation of one or more application streaming sessions for one or more respective applications. In response to receiving the application streaming session request 405, a server 402 is configured to run the respective application on an application instance similar to or the same as application instance 104, 204. The application instance is configured to render and generate application frames (e.g., application frames 234), audio (e.g., application audio 236), drawing data (e.g., drawing data 106, 206), or any combination thereof related to the respective application. The server 402 is then configured to provide the rendered and generated application frames, audio, and drawing data to the client device 416 as an application data stream 410.

In response to receiving the application data stream 410, the client device 416 is configured to display at least a portion of the application data stream 410 so that at least a portion of the respective application is partially or fully simulated on client device 416. While the client device 416 displays at least a portion of the application data stream 410, client device 416 is configured to receive one or more inputs via one or input devices (e.g., input devices 118, 218) included in or otherwise coupled to client device 416. In response to receiving one or more inputs, client device 116 is configured to transmit an input data stream 415 to server 402 including data representing at least a portion of the inputs received by client device 116. In response to receiving the input data stream 415, server 402 is configured to modify at least a portion of the respective application running on the application instance. For example, server 402 is configured to provide at least a portion of the input data stream 415 as an input to the respective application. Once the respective application has been modified, the application instance renders and generates modified application frames, audio, and drawing data based on the modified application. Server 402 then provides the modified application frames, audio, and drawing data to the client device 116 as part of a modified application stream 420.

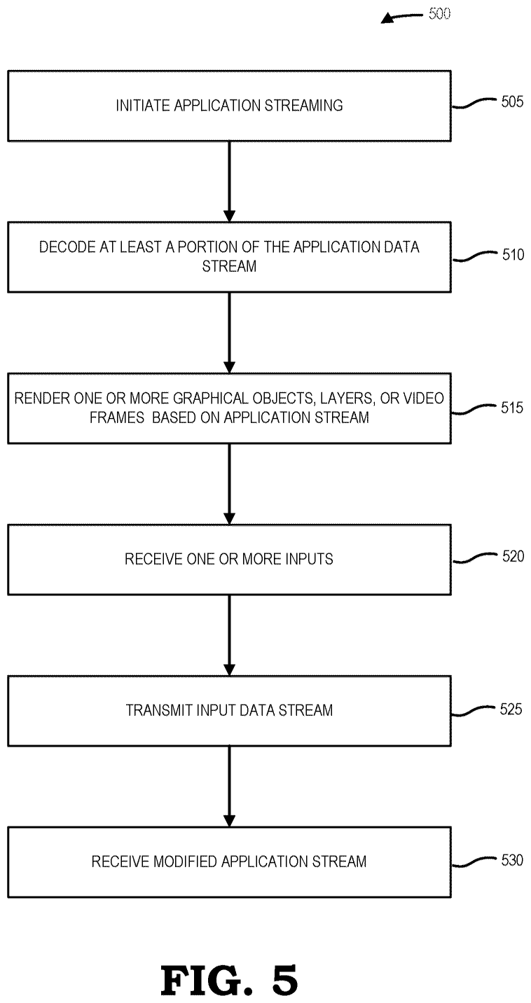

Referring now to FIG. 5, an example method 500 for streaming one or more applications to one or more client devices is presented. At step 505 of method 500, a client device, similar to or the same as client devices 116, 300, 416, initiates application streaming between the client device and one or more servers, similar to or the same as servers 102, 200, 402. For example, the client device transmits data requesting application streaming for a respective application to a server. In response to receiving the data requesting application streaming, a server runs an application identified in the data requesting application streaming on an application instance similar or the same as application instances 104, 204. In embodiments, the application instance renders and generates application frames (e.g., video frames), audio, drawing data, or both that are then encoded and transmitted to the client device as part of an application data stream 114. At step 510, in response to receiving the application data stream 114, the client device is configured to decode at least a portion of the application data stream using one or more decoders, similar to or the same as decoders 124, 324. The client device is then configured to display one or more decoded portions of the application data stream 114 on a display, similar to or the same as display 126, output one or more decoded portions of the application data stream 114 on one or more output devices, similar to or the same as output devices 120, 320, or both.

At step 515, the client device is configured to render one or more graphical objects, layers, images, or video frames based on the application data stream 114. For example, the client device is configured to render one or more graphical objects and layers according to drawing data (e.g., a scene graph), similar to or the same as drawing data 106, 206, in the application data stream 114. As another example, the client device is configured to update one or more graphical objects, layers, video frames, or any combination thereof based on data representing the difference between the attributes of one or more graphical objects, layers, video frames, or any combination and the attributes one or more reference graphical objects, layers, video frames, or any combination thereof in the application data stream 114. After rendering, updating, or both one or more graphical objects, layers, images, or video frames, the client device displays the rendered and updated graphical objects, layers, and video frames on a display alone or concurrently with one or more decoded video frames. At step 520, the client device receives one or more inputs via one or more input devices, similar to or the same as input devices 118, 318, included in or otherwise coupled to the client device. At step 525, in response to receiving one or more inputs, the client device is configured to transmit an input data stream 128 that represents one or more received inputs at the client device to a server. In response to receiving the input data stream 128, a server modifies the respective application by, for example, providing at least a portion of the input data stream 128 as an input to the respective application. The application instance then generates and renders modified application frames, audio, and drawing data based on the modified application. The server provides these modified application frames, audio, and drawing data to the client device as part of a modified application stream. At step 530, the client device receives the modified application stream and displays at least a portion of the modified application stream.

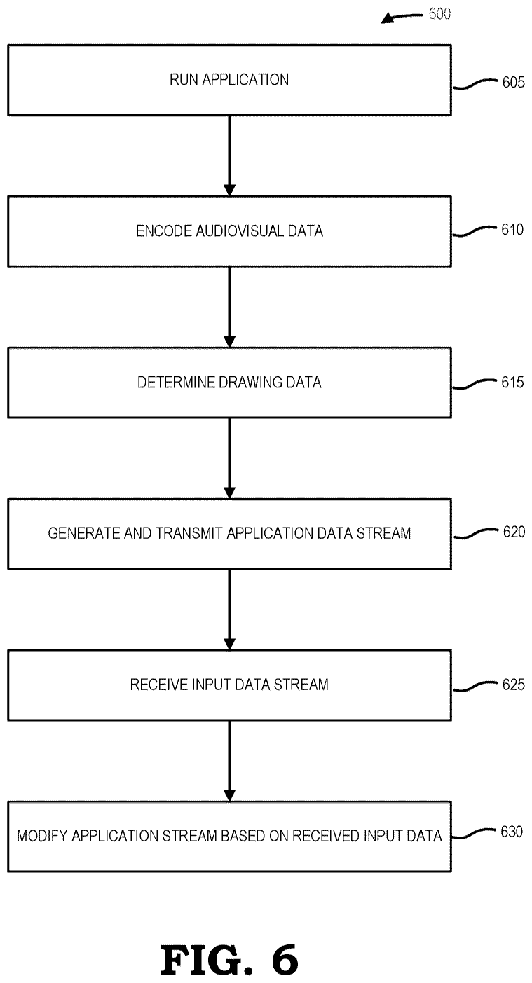

Referring now to FIG. 6., an example method 600 for providing inputs to one or more application data streams is presented. At step 605 of method 600, a server, similar to or the same as servers 102, 200, 402, runs an application on an application instance similar to or the same as application instances 104, 204. While the application is running, the application instance renders and generates audiovisual data, for example, application frames and application audio. At step 610, the server is configured to encode the audiovisual data using one or more video codes, audio codecs, or both. At step 615, the application instance is configured to generate drawing data (e.g., scene graphs), similar to or the same as drawing data 106, 206, used to render graphical objects, layers, images, video frames, or any combination thereof in the audiovisual data rendered by the application instance. In embodiments, the server is configured to determine the drawing data used to render or generate graphical objects, layers, images, and video frames and store the determined drawing data in a drawing data cache, similar to or the same as drawing data cache 250. According to embodiments, storing drawing data in the drawing data cache includes, for example, storing values representing the differences between the attributes of one or more rendered or generated graphical objects, layers, video frames, or any combination and the attributes one or more reference graphical objects, layers, video frames, or any combination thereof.

At step 620, the server transmits an application data stream 114 to one or more client devices. The application data stream 114 includes audiovisual data encoded by the server, drawing data stored in the drawing data cache, or both. At step 625, while the server is transmitting the application data stream 114, the server is configured to receive an input data stream 128 from one or more client devices. The input data stream 128 includes data representing one or more inputs received by the client devices. For example, the input data stream 128 includes encoded video captured by a camera of a client device. At step 630, in response to receiving an input data stream 128, the server is configured to modify the application running on the application instance. For example, the server is configured to provide at least a portion of the input data stream 128 as an input to the application. As another example, the server is configured to determine one or more inputs for the application based on the input data stream 128.

As disclosed herein, in some embodiments a method includes: initiating application streaming between a client device and a cloud-based application server; in response to receiving an application data stream from the cloud-based application server, displaying, at the client device, at least a portion of the application data stream based on drawing data, wherein the application data stream includes the drawing data; and transmitting an input data stream to the cloud-based application server, the input data stream comprising data representing at least one input received at the client device. In one aspect, the method includes: receiving a modified application data stream; and displaying at least a portion of the modified application data stream based on modified drawing data. In another aspect, the method includes: receiving one or more inputs; and encoding the one or more inputs, wherein the input data stream includes the encoded one or more inputs. 4. The method of claim 3, wherein the one or more inputs include video captured by a camera of the client device.

In one aspect, the method includes: outputting at least a portion of the application data stream using one or more output devices. In another aspect, the one or more output devices comprises a speaker of the client device. In still another aspect, the drawing data includes a scene graph for at least a portion of the application data stream. In yet another aspect, the method includes: decoding at least a portion of the application data stream and displaying the decoded at least a portion of the application data stream according to the drawing data. In another aspect, the drawing data comprises a value representing a difference between attributes of a graphical object and a reference graphical object.

In some embodiments, a method includes: initiating application streaming between a client device and a cloud-based application server; transmitting, to the client device, an application data stream including an encoded video frame associated with an application running on the cloud-based application server and drawing data associated with the application; and in response to receiving an input data stream from the client device representing an input received at the client device, modifying the application based on the input. In one aspect, the method includes: transmitting, to the client device, a modified application data stream including an encoded modified video frame associated with the modified application and modified drawing data associated with the modified application. In another aspect, the method includes: decoding at least a portion of the input data stream and providing the decoded at least a portion of the input data stream to the application as an input. In still another aspect, the at least a portion of the input data stream includes encoded video captured from a camera of the client device.

In one aspect, the method includes: determining the drawing data based on the application; and storing the drawing data in a drawing data cache. In another aspect, the drawing data comprises a scene graph for at least a portion of the application data stream. In yet another aspect, the drawing data comprises a value representing a difference between attributes of a graphical object and a reference graphical object.

In one aspect, the application comprises at least one of a video calling application, presentation application, meeting application, or streaming application. In another aspect, the client device comprises a smartphone. In yet another aspect, the client device comprises a browser. In still another aspect, at least a portion of the application data stream is displayable at a plurality of resolutions on the client device.

In some embodiments, a cloud-based application streaming system includes: at least one cloud-based application server; at least one client device including one or more input devices and one or more displays; one or more processing elements; and a memory coupled to the one or more processing elements and storing executable instructions configured to manipulate the one or more processors to perform any of the methods described above.

In some embodiments, a device for cloud-based application streaming includes: a client device communicatively coupled to a cloud-based server; one or more input devices communicatively coupled to the client device; one or more processing elements; and a memory coupled to the one or more processing elements and storing executable instructions configured to manipulate the one or more processors to perform any of the methods described above.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
initiating application streaming between a client device and a cloud-based application server;
in response to receiving an application data stream from the cloud-based application server, displaying, at the client device, at least a portion of the application data stream based on drawing data, wherein the application data stream includes the drawing data; and
transmitting an input data stream to the cloud-based application server, the input data stream comprising data representing at least one input received at the client device.

2. The method of claim 1, further comprising:
receiving a modified application data stream; and
displaying at least a portion of the modified application data stream based on modified drawing data.

3. The method of claim 1, further comprising:
receiving one or more inputs; and
encoding the one or more inputs, wherein the input data stream includes the encoded one or more inputs.

4. The method of claim 3, wherein the one or more inputs include video captured by a camera of the client device.

5. The method of claim 1, further comprising:
outputting at least a portion of the application data stream using one or more output devices.

6. The method of claim 5, wherein the one or more output devices comprises a speaker of the client device.

7. The method of claim 1, wherein the drawing data includes a scene graph for at least a portion of the application data stream.

8. The method of claim 1, the method further comprising:
decoding at least a portion of the application data stream and displaying the decoded at least a portion of the application data stream according to the drawing data.

9. The method of claim 1, wherein the drawing data comprises a value representing a difference between attributes of a graphical object and a reference graphical object.

10. A method comprising:
initiating application streaming between a client device and a cloud-based application server;
transmitting, to the client device, an application data stream including an encoded video frame associated with an application running on the cloud-based application server and drawing data associated with the application; and
in response to receiving an input data stream from the client device representing an input received at the client device, modifying the application based on the input.

11. The method of claim 10, further comprising:
transmitting, to the client device, a modified application data stream including an encoded modified video frame associated with the modified application and modified drawing data associated with the modified application.

12. The method of claim 10, further comprising:
decoding at least a portion of the input data stream and providing the decoded at least a portion of the input data stream to the application as an input.

13. The method of claim 12, wherein the at least a portion of the input data stream includes encoded video captured from a camera of the client device.

14. The method of claim 10, further comprising:
determining the drawing data based on the application; and
storing the drawing data in a drawing data cache.

15. The method of claim 10, wherein the drawing data comprises a scene graph for at least a portion of the application data stream.

16. The method of claim 10, wherein the drawing data comprises a value representing a difference between attributes of a graphical object and a reference graphical object.

17. The method claim 10, wherein the application comprises at least one of a video calling application, presentation application, meeting application, or streaming application.

18. The method of claim 1, wherein the client device comprises a smartphone.

19. The method of claim 1, wherein the client device comprises a browser.

20. The method of claim 1, wherein at least a portion of the application data stream is displayable at a plurality of resolutions on the client device.

21-22. (canceled)
